(19) United States
(12) Patent Application Publication
(10) Pub. No.: US 2019/0054451 A1
(43) Pub. Date: Feb. 21, 2019

(54) STAINLESS STEEL FOAM SUPPORTED CATALYSTS FOR THE OXIDATION OF AROMATIC COMPOUNDS

(71) Applicant: UNIVERSITY COURT OF THE UNIVERSITY OF ST ANDREWS, ST ANDREWS (GB)

(72) Inventors: John Thomas Sirr IRVINE, ST ANDREWS, FIFE (GB); Mark CASSIDY, ST ANDREWS, FIFE (GB); Sneh JAIN, ST ANDREWS, FIFE (GB)

(21) Appl. No.: 16/077,337

(22) PCT Filed: Feb. 10, 2017
(86) PCT No.: PCT/GB2017/050351

§ 371 Date: Aug. 10, 2018

(30) Foreign Application Priority Data
Feb. 12, 2016 (GB) 1602590.0

(51) Int. Cl. B01J 23/745; B01J 23/44; B01J 23/10; B01J 23/755; B01J 23/86; B01D 53/86

(52) U.S. Cl. CPC B01J 23/745; B01J 23/44; B01J 23/10; B01J 23/755; B01J 23/862; B64D 13/06; B01D 2255/1023; B01D 2255/2065; B01D 2255/20738; B01D 2255/20753; B01D 2257/708; B01D 53/8668

(57) ABSTRACT

The invention provides a catalyst comprising iron oxide, nickel, ceria or palladium supported on stainless steel foam. The catalyst is effective in oxidising aromatic compounds such as toluene and o-cresol and, advantageously, is particularly effective when the oxidation is carried out at elevated temperatures that correspond to temperatures attained in areas of the aircraft where cabin air is recirculated.

### FIELD OF THE INVENTION

The invention relates to stainless steel foam supported catalysts which are useful in the oxidation of aromatic compounds. One aspect of the invention includes the use of these catalysts in a method of treating air in an air handling system.

### BACKGROUND OF THE INVENTION

In a typical passenger aircraft, the cabin air system is such that air passes from the bottom of the cabin, through the recirculation filters, into the mixing chamber where it is mixed with outside air (50/50) and then passed back into the cabin. HEPA filters (high efficiency particulate air filters) are used in the cabin air recirculation system to improve cabin air quality by removing particulate contamination (e.g. dust, fibers, skin flakes, droplets) and can be used to remove bacteria and viruses. However such filters are not capable of removing volatile organic compounds (VOCs). VOCs may be present in both the recirculated air and outside air entering the air circulation system. These can come from hydraulic fluids, engine lubricants, jet fuels, de-icing fluids, inflight catering and human bio-effluent. The presence of these compounds is undesirable as they produce odours and may be harmful to human health. Indeed, a substantial body of evidence has accumulated over the past thirty years on episodes of nausea, dizziness and disorientation which have been experienced by aircraft crew and passengers after flying in aircraft (the term ‘aerotoxic syndrome’ has been coined to describe this phenomenon). One widely cited cause of these symptoms is an organophosphorus compound called tricresyl phosphate ((CH₃C₆H₄O)₃P, abbreviated herein as TCP), which is an additive found in aircraft engine lubricant oils. Small amounts of TCP and its decomposition products may leak into the aircraft's cabin air system from the engine during a flight, causing sickness episodes in passengers and crew. Toluene and o-cresol are such decomposition products and are harmful or, in the case of o-cresol, very harmful to human health. There are currently no other non-toxic alternatives to TCP as a jet engine oil lubrication additive.

There is a need to provide a method of improving aircraft cabin air quality. In particular, there is a need to prevent passengers and crew in an aircraft cabin from exposure to volatile organic compounds such as TCP and its degradation products.

Further, it is desirable that any such method can be carried out in an aircraft without having to substantially modify the internal fittings of the aircraft and/or, that it can be carried out under normal aircraft operating conditions. Thus, there is a need for proving a method of improving aircraft cabin air quality that can be implemented in an aircraft air handling system with good energy efficiency.

It is an object of the invention to solve at least one of the afore-mentioned problems or meet at least one of the afore-mentioned needs.

### SUMMARY OF THE INVENTION

In a first aspect, the invention provides a catalyst comprising iron oxide, nickel, ceria or palladium supported on stainless steel foam. It has been found that the catalysts of the invention are effective in oxidising aromatic compounds such as toluene and o-cresol. Advantageously, the oxidation is particularly effective at elevated temperatures that correspond to temperatures attained in areas of the aircraft where cabin air is recirculated. Thus, this catalyst is particularly suited for use in the treatment of air passing through an aircraft air handling system to remove undesirable volatile aromatic compounds.

In a second aspect, the invention provides a method of oxidising aromatic compounds using the catalyst of the first aspect of the invention. In particular the second aspect relates to a method of oxidising a compound of formula (I):

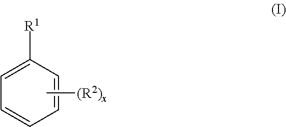

where R¹ is a hydrocarbyl group having from 1 to 5 carbon atoms, —R² is chosen from —OH, a group of formula (II), (III), or (IV)

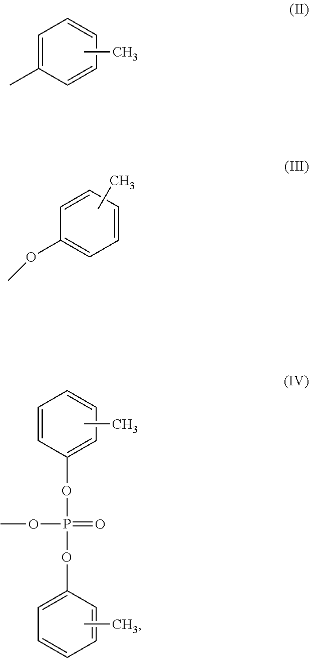

a hydrocarbyl group having from 1 to 5 carbon atoms, —Br, —Cl or —Fl and x is from 0 to 2; and wherein said method comprises heating the compound with a gas containing oxygen in the presence of the catalyst of the first aspect of the invention. The oxidation reaction renders products such as CO₂, which are relatively harmless to human health.

In a third aspect, the invention provides a method of treating air in an air handling system comprising heating the air at a temperature of from 150 to 450 or 200 to 400° C. in the presence of the catalyst of the first aspect of the invention. Thus the invention provides a method of purifying air in an air handling system, such as an aircraft cabin air handling system.

### BRIEF DESCRIPTION OF THE DRAWINGS

FIG. 1: MS data for m/z=91 (tolyl ion) and m/z=44 (CO₂) for toluene vapour passed through heated column. Partial pressure measured as a function of temperature.

FIG. 2: MS data for m/z=91 (tolyl ion) and m/z=44 (CO₂) for toluene vapour passed through uncoated stainless steel foam. Partial pressure measured as a function of temperature.

FIG. 3: MS data for m/z=91 (tolyl ion) and m/z=44 (CO₂) for toluene vapour passed through plumbers wool. Partial pressure measured as a function of temperature.

FIG. 4: MS data for m/z=91 (tolyl ion) and m/z=44 (CO₂) for toluene vapour passed through iron oxide coated stainless steel foam. Partial pressure measured as a function of temperature.

FIG. 5: MS data for m/z=91 (tolyl ion) and m/z=44 (CO₂) for toluene vapour passed through nickel coated stainless steel foam. Partial pressure measured as a function of temperature.

FIG. 6: MS data for m/z=91 (tolyl ion) and m/z=44 (CO₂) for toluene vapour passed through ceria coated stainless steel foam. Partial pressure measured as a function of temperature.

FIG. 7: MS data for m/z=91 (tolyl ion) and m/z=44 (CO₂) for toluene vapour passed through palladium coated stainless steel foam. Partial pressure measured as a function of temperature.

FIG. 8: Concentration of o-cresol captured in 20 cm³ of water after contact with metal foam with no metal catalysts loaded for one hour as a function of temperature.

FIG. 9: Concentration of o-cresol captured in 20 cm³ of water after contact with catalyst, steel foam coated with ceria for one hour as a function of temperature.

FIG. 10: Concentration of o-cresol captured in 20 cm³ of water after contact with catalyst, steel foam coated with iron oxide for one hour as a function of temperature.

FIG. 11: Concentration of o-cresol captured in 20 cm³ of water after contact with catalyst, steel foam coated with Pd for one hour as a function of temperature.

FIG. 12: Concentration of o-cresol captured in 20 cm³ of water after contact with catalyst, steel foam coated with Ni for one hour, as a function of temperature.

### DETAILED DESCRIPTION OF THE INVENTION

In a first aspect, the invention provides a catalyst comprising iron oxide, nickel, ceria or palladium supported on stainless steel foam.

The catalyst of the invention utilises a stainless steel foam support. Stainless steel is an iron alloy which contains chromium, typically in an amount of at least 10.5 wt % chromium. Suitable stainless steel foam supports are commercially available, for example, stainless steel 314 foam 40-ppi, 4.5% density (Porvair). In one embodiment, the steel has a SAE (Society of Automotive Engineers)/AISI (American Iron and Steel Institute) grade with 3 prefix. A suitable support is SAE/AISI grade 314 stainless steel.

The stainless steel foam utilised in the support has an open cellular structure. Suitable stainless steel foam has a density of from 0.04 to 0.95 gcm⁻³. Suitable stainless steel foam has a BET surface area of, for example 0.1096 m²/g.

The stainless steel foam support is loaded with one of iron oxide, nickel, ceria or palladium. This catalytic material can be deposited on the support by means known in the art. A suitable method involves: (a) coating the stainless steel foam support with a metal nitrate solution, where the metal is Fe, Ni, Ce or Pd; (b) drying the solution on the support by heating the coated support to about 80° C.; (c) heating the support to about 300° C. at a rate of 2° C./min and keeping it at this temperature for about 1 hour; (d) cooling the support to room temperature at a rate of 2° C./min; (e) applying a further coat of the metal nitrate solution to the stainless steel foam support; and (f) heating the support to about 480° C. and keeping it at this temperature for about 1 hour in air.

The catalyst of the invention comprises iron oxide, nickel, ceria or palladium. In one embodiment, the catalyst of the invention comprises iron oxide, ceria or palladium. Suitable catalysts have a have a metal (i.e. nickel, ceria or palladium) or metal oxide (iron oxide) loading of from 2 to 15 wt %, preferably 5 to 10 wt %, based on the total weight of the catalyst. This weight percentage can be determined by weight measurements at room temperature.

In a second aspect, the invention provides a method of oxidising aromatic compounds, in particular tricresyl phosphate and its degradation products, using the catalyst of the first aspect of the invention. In particular the second aspect relates to a method of oxidising a compound of formula (I):

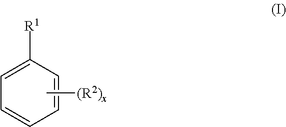

where R¹ is a hydrocarbyl group having from 1 to 5 carbon atoms, —R² is chosen from —OH, a group of formula (II), (III), or (IV)

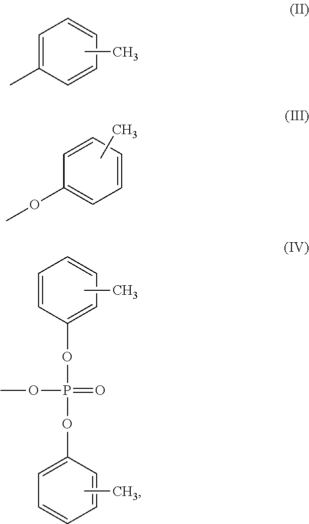

a hydrocarbyl group having from 1 to 5 carbon atoms, —Br, —Cl or —Fl and x is from 0 to 2; and wherein said method comprises heating the compound in a gas containing oxygen in the presence of a catalyst comprising iron oxide, nickel, ceria or palladium supported on stainless steel foam.

R¹ is a hydrocarbyl group containing 1 to 5 carbon atoms and can contain 1 to 3 carbon atoms. In one embodiment, R¹ is an aliphatic hydrocrabyl group such as an alkyl or alkenyl group. Preferably R¹ is an alkyl group. In a preferred embodiment R¹ is a methyl group.

R² can be a hydrocarbyl group containing 1 to 5 carbon atoms and can contain 1 to 3 carbon atoms. In this embodiment, R² can be an aliphatic hydrocarbyl group such as an alkyl or alkenyl group, preferably an alkyl group. In a preferred embodiment R² is a methyl group.

In one embodiment, the second aspect of the invention relates to a method of oxidising a compound of formula (I):

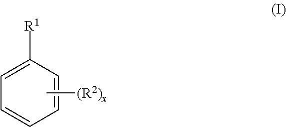

where R¹ is a methyl, —R² is chosen from —OH, a group of formula (II), (III), or (IV)

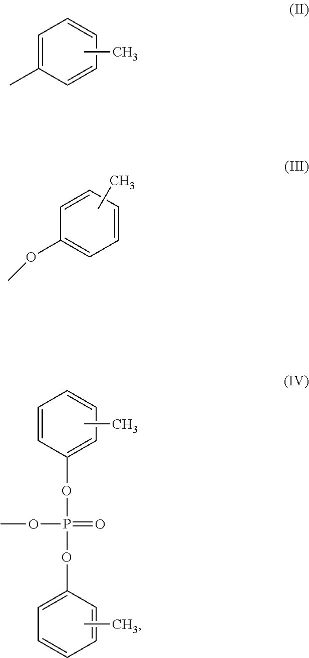

and x is from 0 to 2; and wherein said method comprises heating the compound in a gas containing oxygen in the presence of a catalyst comprising iron oxide, nickel, ceria or palladium supported on stainless steel foam.

In one embodiment, x is zero and the compound of formula (I) is a mono-substituted aromatic ring. In this embodiment, preferably R¹ is an alkyl group, preferably a alkyl group selected from methyl, ethyl and propyl. In a preferred embodiment, the compound of formula (I) is toluene, i.e. x is 0 and R¹ is a methyl group. When x is 0, and, in particular, when the compound of formula (I) is toluene, preferably the catalyst comprises palladium supported on stainless steel foam.

In one embodiment, x is 1 or 2, i.e. the compound of formula (I) is a di- or tri-mono-substituted aromatic ring.

In one embodiment, x is 1 and R² is OH. In one embodiment, R² is positioned in the ortho position with respect to R¹, i.e. on the carbon atom of the aromatic ring adjacent to the carbon atom bonded to R¹. In this embodiment, preferably R¹ is an alkyl group, preferably a alkyl group selected from methyl, ethyl and propyl. In a preferred embodiment, the compound of formula (I) is cresol, i.e. x is 1 and R¹ is a methyl group and R² is OH. More preferably, R² is in the ortho position, i.e. the compound of formula (I) is o-cresol. When x is 1, and, in particular, when the compound of formula (I) is o-cresol, preferably the catalyst comprises iron oxide supported on stainless steel foam.

In one embodiment, x is 1 and R² is a group of formula (II), (III) or (IV). In one embodiment, R² is positioned in the meta or the para position with respect to R¹. In this embodiment, when R² is a group of formula (II), (III), the compound of formula (I) is preferably a degradation product of tricresyl phosphate. In this embodiment, when R² is a group of formula (IV), the compound of formula (I) is tricresyl phosphate.

Preferably the compound of formula (I) is gaseous under ambient conditions, i.e. at atmospheric pressure and room temperature.

In the method of the second aspect of the invention, the compound of formula (I) is heated in a gas containing oxygen in the presence of the catalyst of the first aspect of the invention. The features pertaining to the catalyst as described above for the first aspect of the invention pertain to the catalyst as referred to in the second aspect of the invention.

In the method, the compound of formula (I) is heated in an oxygen containing gas, for example air. The air can be that present in an air handling system, such as the cabin air handling system on an aircraft. The compound is heated so that it will react with the oxygen, i.e. it will oxidise, forming for example, water and CO₂. Typically, the compound is heated in the oxygen-containing gas to temperatures of from 150 to 450° C., preferably from 200 to 400° C. In one embodiment, when the catalyst comprises iron oxide, the compound is heated in the oxygen-containing gas to temperatures of greater than 350° C., preferably at least 400° C. It has been found that the iron oxide-based catalyst is particularly effective at these temperatures. In one embodiment, when the catalyst comprises palladium, the compound is heated in the oxygen-containing gas to temperatures of at least 250° C. It has been found that the palladium-based catalyst is particularly effective in this temperature range. In one embodiment, when the catalyst comprises ceria, the compound is heated in the oxygen-containing gas to temperatures of from 200 and 250° C. It has been found that the ceria-based catalyst can be particularly effective in this temperature range.

In a third aspect, the invention provides a method of treating air in an air handling system comprising heating the air in the presence of the catalyst of the first aspect of the invention. By this method any aromatic compounds of formula (I) present in the air will be removed, by oxidation (as described for the first aspect of the invention) and effectively replaced by the relatively harmless products of the oxidation. Thus this is a method of treating pollutants, such as TCP and the decomposition products of TCP (toluene and o-cresol) in air. Typically, the air is heated to temperatures of from 150 to 450° C., preferably from 200 to 400° C. The features pertaining to the catalyst as described above for the first aspect of the invention pertain to the catalyst as referred to in the third aspect of the invention. In one embodiment, when the catalyst comprises iron oxide, the air is heated to temperatures of greater than 350° C., preferably at least 400° C. In one embodiment, when the catalyst comprises palladium, the air is heated to temperatures of at least 250° C. It has been found that the palladium-based catalyst is particularly effective in this temperature range. In one embodiment, when the catalyst comprises ceria, the air is heated to temperatures of from 200 and 250° C. It has been found that the ceria-based catalyst can be particularly effective in this temperature range.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:
hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);
substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy);
hetero substituents, that is, substituents which, while having a predominantly hydrocarbon character, in the context of this invention, contain other than carbon in a ring or chain otherwise composed of carbon atoms and encompass substituents as pyridyl, furyl, thienyl and imidazolyl. Heteroatoms include sulfur, oxygen, and nitrogen. In general, no more than two, or no more than one, non-hydrocarbon substituent will be present for every ten carbon atoms in the hydrocarbyl group; alternatively, there may be no non-hydrocarbon substituents in the hydrocarbyl group. In one embodiment, there are no halo substituents in the hydrocarbyl group.

It is to be understood that the upper and lower amount, range, and ratio limits set forth herein may be independently combined. Similarly, the ranges and amounts for each element of the invention can be used together with ranges or amounts for any of the other elements. As used herein, the term “comprising” is intended also to encompass as alternative embodiments “consisting essentially of” and “consisting of.” “Consisting essentially of” permits the inclusion of substances that do not materially affect the basic and novel characteristics of the composition under consideration.

The following examples provide illustrations of the disclosed technology. The examples are non-exhaustive and are not intended to limit the scope of the disclosed technology.

Preparation of Catalysts

The catalysts used are stainless steel 314 foam 40-ppi, 4.5% density (Porvair) which have been coated. The stainless steel foam surface area was measured at the University of St Andrews (BET surface area=0.1096 m²/g) and was cut into cubes of 1.2×1.2×1.2 cm dimensions and were ca. 0.5 g each. These cubes were coated with metal nitrate solution in 1,2 propanediol in 0.2 mol dm⁻³ Fe(NO₃)₂, dried at 80° C. in an oven and then the respective metal nitrates were decomposed at 300° C., (heating rate 2° C./min) and held for 1 hour, and then cooled to room temperature (2° C./min). A fresh coating of metal nitrate was applied, and the material was dried under the same regime (at 80° C.). The metal nitrate-coated foam was then transferred to a furnace and decomposed at 480° C. for one hour in air. The typical load of metal catalyst on the foam was typically between 5-10%, as shown by weight measurements at room temperature. Experiments were performed by placing the catalyst on the alumina tube. Vapour was passed by bubbling compressed air through the flask containing either the toluene or o-cresol. Experiments were performed sequentially, with each of the four catalysts being heated in a stepwise fashion from 200° C. to 400° C. at 50° C. intervals.

The four catalysts prepared are detailed in the table below:

| | | | Resultant |
|---|---|---|---|
| | | | deposited catalytic |
| | Support material | Metal nitrate | material |
| Example 1 | Stainless steel | Fe(NO₃)₃•9H₂O | FeO₃ |
| | foam | | |
| Example 2 | Stainless steel | Ni(NO₃)₂ | Ni |
| | foam | | |
| Example 3 | Stainless steel | Ce(NO₃)₃•6H₂O | Ce |
| | foam | | |
| Example 4 | Stainless steel | Pd(NO₃)₂ | Pd |
| | foam | | |
| Reference | Stainless steel | none | none |
| Example 1 | foam | | |
| Reference | Plumbers wool | none | none |
| Example 2 | | | |

### Experiment 1—Decomposition of Toluene

Toluene, in a three necked round bottom flask at ambient temperature had a stream of compressed air bubbled through it. The vapour was passed through a quartz column which contains a catalyst, if a catalyst is being used, at temperatures between 200-400° C. The exhaust gases were analysed by in-situ mass spectrometry (MS). Specifically, the concentration of the tolyl ion (C₆H₄CH₃⁺) at m/z=91 and the combustion product CO₂ at m/z=44 were monitored using in-situ MS. This procedure was repeated several times using different catalysts/non-catalysts.

In a first run, no catalyst was used and the concentration of output gases from the thermal degradation of toluene under these conditions are shown in FIG. 1.

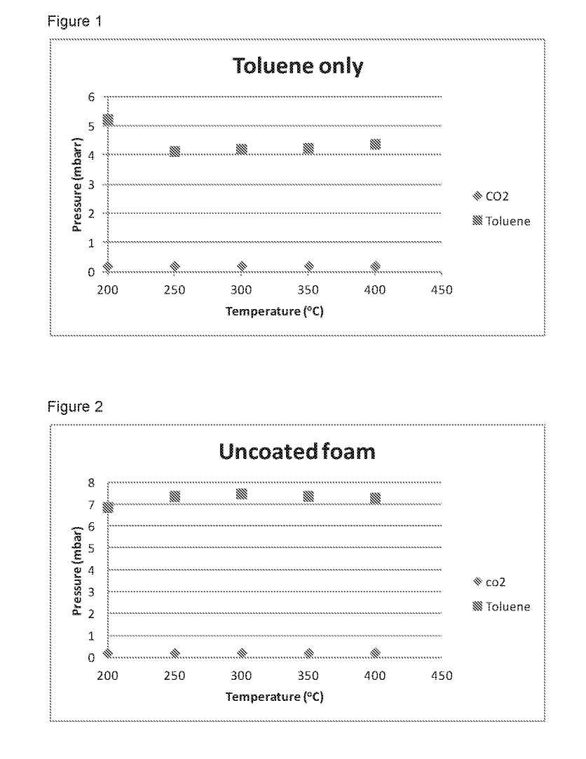

In a second run, uncoated stainless steel foam (Reference Example 1) was present in the quartz column. The results are shown in FIG. 2.

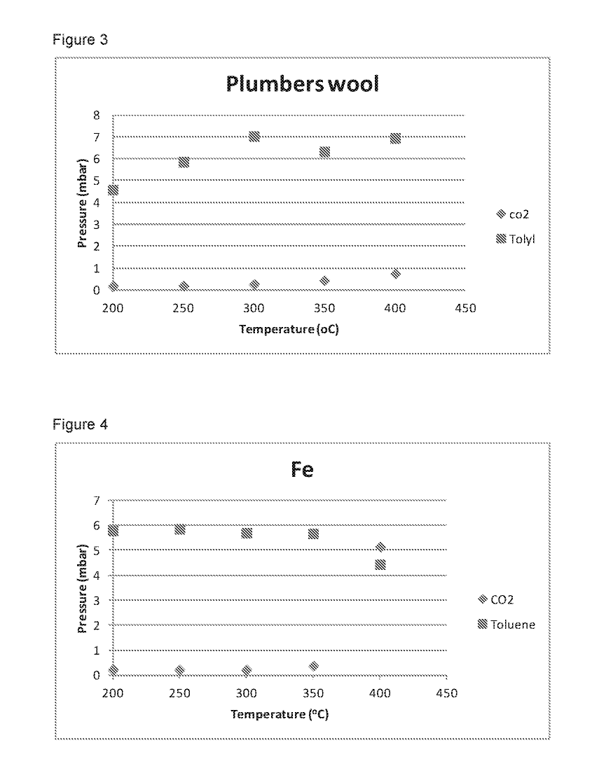

In a third run, plumbers wool (Reference Example 2) was present in the quartz column. The results are shown in FIG. 3.

In a fourth run, iron oxide coated stainless steel foam (Example 1) was present in the quartz column. The results are shown in FIG. 4.

In a fifth run, nickel coated stainless steel foam (Example 2) was present in the quartz column. The results are shown in FIG. 5.

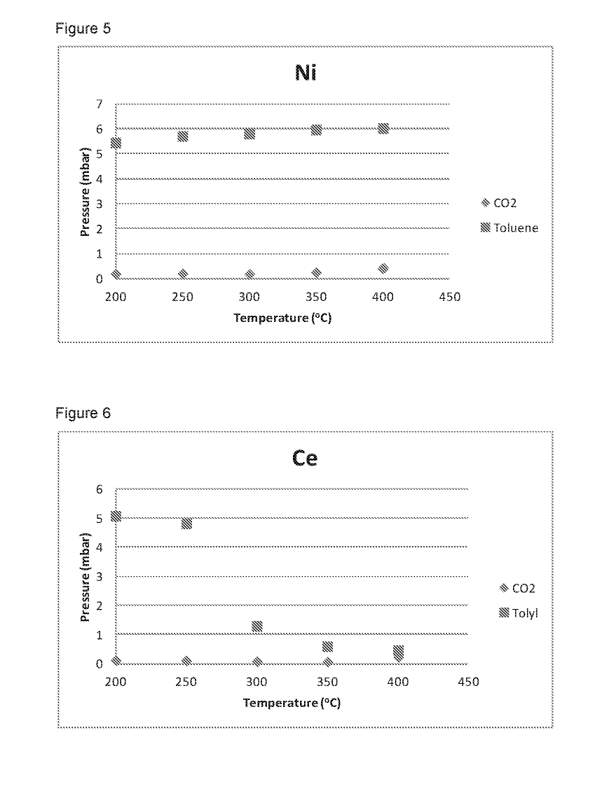

In a sixth run, ceria coated stainless steel foam (Example 3) was present in the quartz column. The results are shown in FIG. 6.

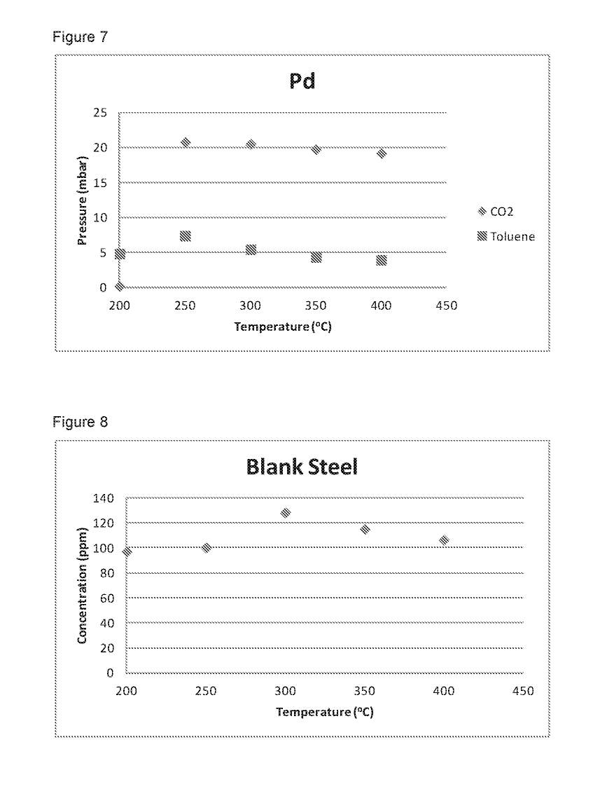

In a seventh run, palladium coated stainless steel foam (Example 4) was present in the quartz column. The results are shown in FIG. 7.

The key parameter in each figure is the CO₂ concentration and the tolyl ion concentration decrease. An increased CO₂ concentration indicates that decomposition of toluene has occurred. FIGS. 2, 3 and 5 show that the CO₂ concentration is constant between 200° C. and 400° C., i.e. there is no decomposition of toluene to CO₂ at any of uncoated foam, plumbers wool or nickel coated foam. FIG. 4 shows that an iron oxide coating increases toluene degradation above 350° C., as shown by the increased CO₂ concentration, but is inactive below that temperature. Ceria shows good activity (FIG. 6), but palladium coating is by far the most effective catalyst, with decomposition beginning at 250° C., but reaching a plateau thereafter (FIG. 7).

We note that the concentration of toluene used in these studies, approaching 10,000 ppm, is much higher than would be encountered in aircraft cabin air, typically.

### Experiment 2—Decomposition of o-Cresol

O-cresol, in a three necked round bottom flask was warmed to 30° C. in a water bath, at which point the cresol melts. A stream of compressed air was bubbled through the molten o-cresol for an hour and the vapour passed through a quartz tube which contains a catalyst, if a catalyst is being used, at temperatures between 200-400° C. The o-cresol in the exhaust vapour was trapped in deionised water (solubility 20 g dm⁻³ at 20° C.) and measured by UV-vis. A peak at 271 nm was used to quantify the residual cresol. This procedure was repeated several times using different catalysts/non-catalysts.

O-cresol has a vapour pressure of 0.3 mmHg at 20° C., and in-situ techniques available are insufficiently sensitive to measure the cresol concentration; the produced CO₂ concentration was too low to be measured either by GC or MS. Instead UV-vis spectroscopy was used to quantify the o-cresol concentration in the exhaust.

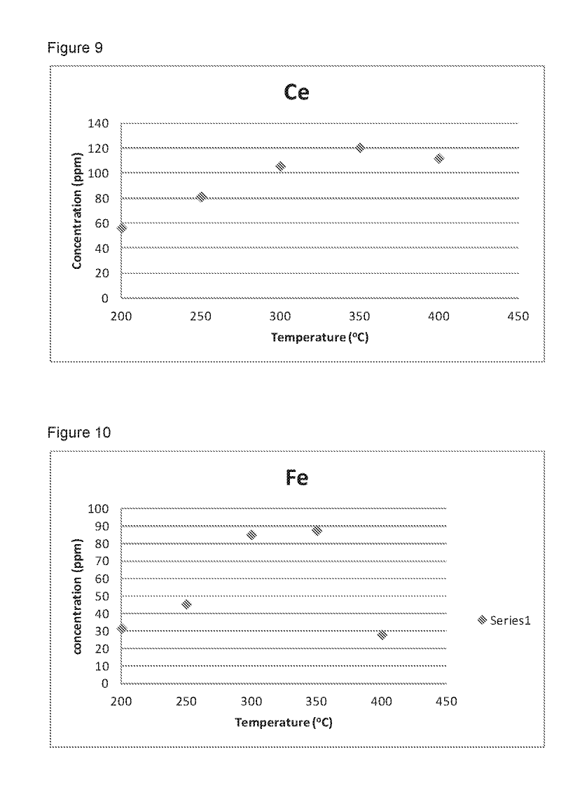

In parallel experiments, o-cresol was decomposed on a range of surfaces (steel, Plumbers wool, and four metal or metal-oxide impregnated stainless steel catalysts). In FIGS. 9 to 13, a decreasing concentration of o-cresol indicates there has been decomposition at the metal surface. These were quantified by UV-vis.

In a first run, uncoated stainless steel foam (Reference Example 1) was present in the quartz column and the concentration of output gases from the thermal degradation of O-cresol under these conditions are shown in FIG. 8.

In a second run, ceria coated stainless steel foam (Example 3) was present in the quartz column. The results are shown in FIG. 9.

In a third run, iron oxide coated stainless steel foam (Example 1) was present in the quartz column. The results are shown in FIG. 10.

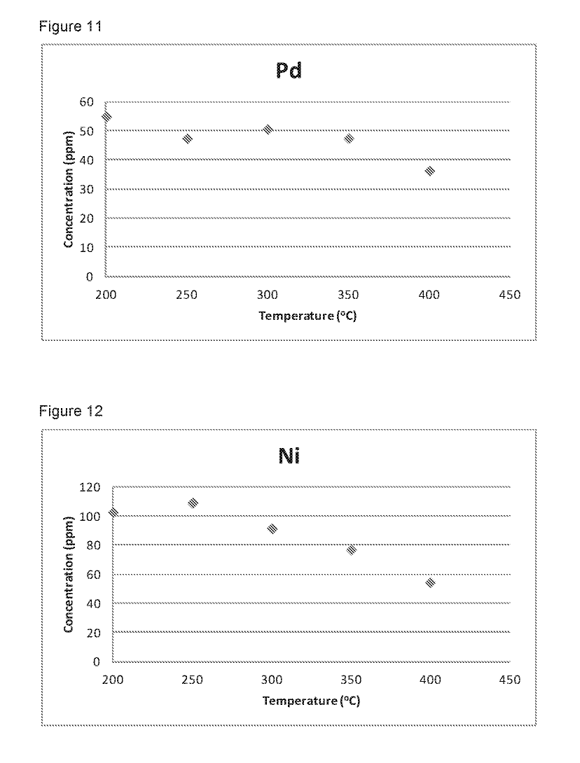

In a fourth run, palladium coated stainless steel foam (Example 4) was present in the quartz column. The results are shown in FIG. 11.

In a fifth run, nickel coated stainless steel foam (Example 2) was present in the quartz column. The results are shown in FIG. 12.

The blank steel sample shows similar behaviour to that of o-cresol with no metal catalyst present. The four metal impregnated stainless steel catalysts behave very differently from each other, and markedly so from the toluene experiments. For Ceria, the catalyst shows some activity at 200 and 250° C., but is essentially inactive above 300° C., this might suggest that removal is more to do with chemisorptions, or the catalytic process yields a product that poisons the ceria surface, such as happens with hydrocarbon coking under non-oxidising conditions. The iron oxide catalyst shows an unusual behaviour. Catalytic performance between 300-350° C. is markedly lower than at temperatures above and below this range. We tentatively suggest that the process of removal of o-cresol at the iron oxide surface changes over the 200-400° C. range, with probably full catalytic decomposition occurring at the higher temperatures, rather than removal. At the lowest temperatures the nano-particulate iron oxide surface will not change so much from that of the as prepared; however as temperature increases it could become fully oxidised and then may become reduced again as preparation temperature is approached. Palladium and nickel show modest improvement in activity as the temperature rises, but do not reach the levels shown by iron oxide.

1. A catalyst comprising iron oxide, nickel, ceria or palladium supported on stainless steel foam.

2. A catalyst according to claim 1, wherein the iron oxide, nickel, ceria or palladium is present in an amount of 2 to 15 wt %.

3. A catalyst according to claim 1, wherein the catalyst comprises iron oxide.

4. A catalyst according to claim 1, wherein the catalyst comprises nickel.

5. A catalyst according to claim 1, wherein the catalyst comprises ceria.

6. A catalyst according to claim 1, wherein the catalyst comprises palladium.

7. A method of oxidising a compound of formula (I): 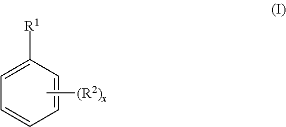
where R¹ is a hydrocarbyl group having from 1 to 5 carbon atoms, —R² is chosen from —OH, a group of formula (II), (III), or (IV) 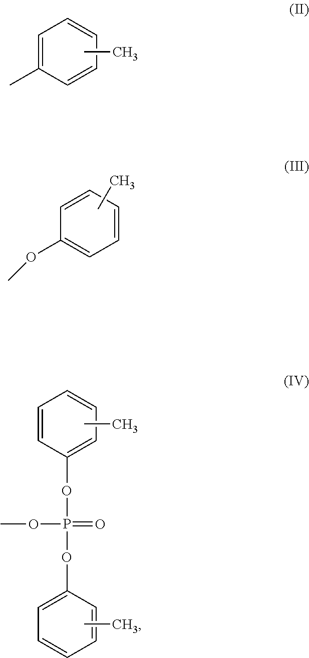
a hydrocarbyl group having from 1 to 5 carbon atoms, —Br, —Cl or —Fl and x is from 0 to 2;
and wherein said method comprises heating the compound in a gas containing oxygen in the presence of a catalyst comprising iron oxide, nickel, ceria or palladium supported on stainless steel foam.

8. A method according to claim 7, wherein the compound in a gas containing oxygen is heated in the presence of said catalyst to a temperature of from 150° C. to 450° C., or 200 to 400° C.

9. A method of treating air in an air handling system comprising heating the air in the presence of a catalyst comprising iron oxide, nickel, ceria or palladium supported on stainless steel foam.

10. A method according to claim 9, wherein the air is heated in the presence of said catalyst to a temperature of from 150° C. to 450° C. or 200 to 400° C.

11. A catalyst according to claim 2, wherein the catalyst comprises iron oxide.

12. A catalyst according to claim 2, wherein the catalyst comprises nickel.

13. A catalyst according to claim 2, wherein the catalyst comprises ceria.

14. A catalyst according to claim 2, wherein the catalyst comprises palladium.
